(19) United States
(12) Patent Application Publication
(10) Pub. No.: US 2009/0230859 A1
(43) Pub. Date: Sep. 17, 2009

(54) Enhanced Brightness Light Emitting Device

(76) Inventor: Kai-Shon Tsai, Lujhou City (TW)

Correspondence Address: BACON & THOMAS, PLLC, 625 SLATERS LANE, FOURTH FLOOR, ALEXANDRIA, VA, 22314-1176, US

(21) Appl. No.: 12/470,982

(22) Filed: May 22, 2009

Related U.S. Application Data
(63) Continuation-in-part of application No. 11/330,331, filed on Jan. 12, 2006.

(51) Int. Cl. H01J 1/63

(52) U.S. Cl. 313/504

(57) ABSTRACT

There is provided an enhanced brightness light emitting device, comprising a light emitting element, and a transparent encapsulation layer which encloses the light emitting element. The transparent encapsulation layer includes a resin and a fluorescent material selected from a non-aromatic fluorescent material, an aromatic fluorescent material, and a non-aromatic fluorescent material containing silicon.

### CROSS REFERENCE

This application is a continuation-in-part of U.S. patent application Ser. No. 11/330,331 filed on Jan. 12, 2006, which is incorporated herewith by reference.

### BACKGROUND OF THE INVENTION

1. Field of the Invention

The present invention generally relates to a light emitting device, and in particular to an enhanced brightness light emitting device comprising an encapsulation layer containing a very small amount of fluorescent material in it so as to solve the problems of color spots and halo phenomena occurred in the conventional light emitting diodes (LEDs).

2. The Prior Arts

The fluorescent whitening agents can be applied in many fields, and mainly in cleaner (such as soaps and detergents), paper, textile, plastic, oil, painting, and the like. With the development of science and technology, the applied range of the fluorescent whitening agent has been increased. For example, the fluorescent whitening agent can be applied in the fluorescent probes, lasers, and especially in the LEDs. Recently, in the LED technology, most of the researches have been focused on the inorganic system. However, the inorganic compounds can cause the problems of heavy metal pollution. Furthermore, the light emitted by the conventional LEDs usually appears color spots (black or yellow spots) and halo phenomena due to its low brightness.

Thus, a need exists for an environmental-friendly light emitting device having high brightness and high luminous efficiency, and not showing color spots (such as black or yellow spots), and halo phenomena.

In U.S. Pat. No. 6,841,933, Yamanaka et al. disclosed that the organic fluorescent whitening agent (for example, 1,4-bis(2-methylstyryl)benzene (Bis-MSB) and trans-4,4′-diphenylstilbene (DPS)) can be used as phosphor for the white LEDs. However, the organic fluorescent whitening agent is usually degraded under UV irradiation. Therefore, when the conventional organic fluorescent whitening agents are used as the phosphor for LEDs, the brightness of LED always decreases over time. Furthermore, the organic fluorescent whitening agents are also easily degraded under high voltage and high temperature (>300° C.). Moreover, the conventional organic fluorescent whitening agents are not compatible with silicone resins which are widely used as an encapsulating material for LEDs and other semiconductors.

Moreover, because the blue LEDs can emit a light of wavelength of 450 nm or below (about 20% of light emitted by the blue LEDs), the eyes of users will be hurt. Furthermore, when the white LEDs are fabricated by combining the blue LEDs and YAG:Ce³⁺, the brightness can be enhanced significantly by such a combination only if the emitted light has a wavelength of between 420 to 470 nm. However, the brightness cannot be enhanced if the light source emits a wavelength of 410 nm or below. Moreover, when the encapsulation layer of the LED contains the conventional fluorescent material (such as 4,4′-bis(2-methoxystyryl)biphenyl) at a concentration ranging from 0.005 to 0.01 wt % based on the total weight of the encapsulation layer, the brightness of the LED actually decreases.

### SUMMARY OF THE INVENTION

The objective of the present invention is to provide an enhanced brightness light emitting device with high brightness in order to overcome the problems set forth above.

To achieve the foregoing objective, the present invention provides an enhanced brightness light emitting device, comprising a light emitting element, and a transparent encapsulation layer which encloses the light emitting element. The transparent encapsulation layer includes a resin and a fluorescent material, and the fluorescent material is represented by the following general formula (I):

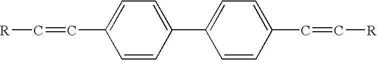

wherein R is selected from one of the group consisting of phenyl substituted with alkoxy, substituted or unsubstituted anthracene group, substituted or unsubstituted pyrene group, and substituted or unsubstituted 9,10-anthraquinone group.

Also, the fluorescent material of the present invention can be selected from the group consisting of the following chemical structural formulae:

### 1. Non-Aromatic Fluorescent Materials:

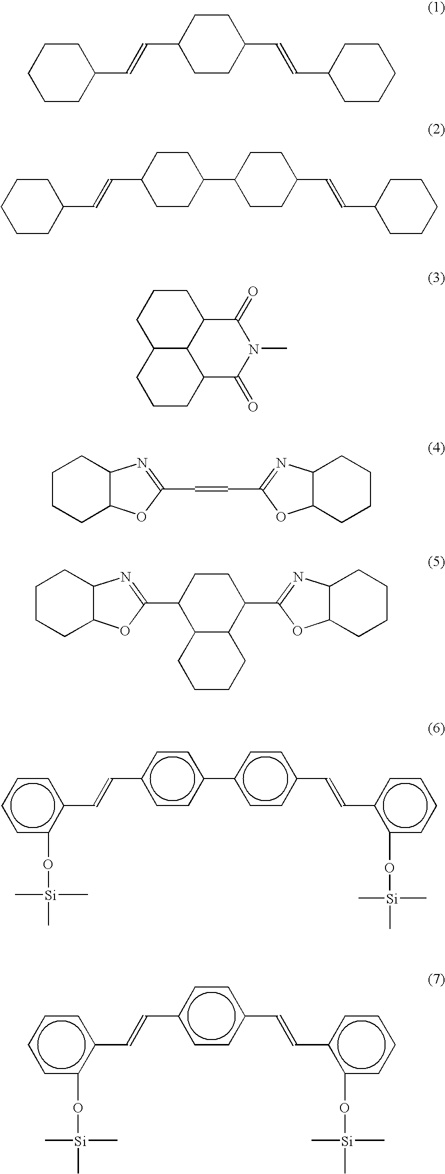

### 2. Aromatic Fluorescent Materials Containing Silicon:

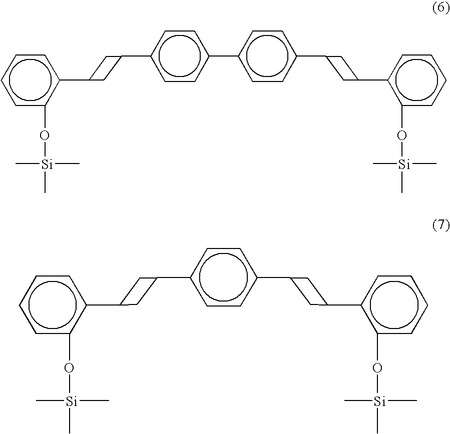

### 3. Non-Aromatic Fluorescent Materials Containing Silicon:

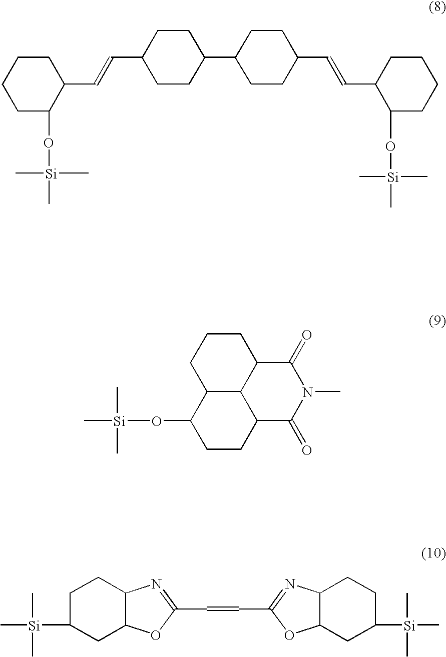

The enhanced brightness light emitting device of the present invention can further comprise a photoluminescent phosphor (such as YAG:Ce³⁺) disposed over the light emitting element, which can emit a second light upon excitation, wherein the first light emitted by the light emitting element can excite the photoluminescent phosphor, which subsequently emits a second light which has longer wavelength than the first light, and the second light and the first light unabsorbed by the photoluminescent phosphor are combined in the encapsulation layer including the resin and the fluorescent material, and then the fluorescent material is excited and emits a visible light with high brightness and high luminous efficiency outwards from the encapsulation layer.

It is worthy to be noticed that the fluorescent material represented by the above structural formulae can substantially completely absorb the light having a wavelength between 254 nm and 475 nm, and subsequently re-emit it with very high brightness, and thereby the problems of color spots (such as black or yellow spots) and halo phenomena occurred in the conventional LED can be eliminated. Moreover, the fluorescent materials used in the present invention are environmental-friendly materials, and they will not cause heavy metal pollution, and harmful metal radiation problems. Furthermore, the used amount of the fluorescent material of the present invention for achieving high brightness is extremely low.

On the other hand, the utensils coated with the fluorescent materials of the present invention can have anti-UV function, and moreover a light can easily penetrate through a board coated with the fluorescent materials of the present invention.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a cross-sectional view of the enhanced brightness light emitting device according to one embodiment of the present invention;

FIG. 2 is brightness (LM)-time curves illustrating the variation in the brightness of the light emitting device corresponding to its encapsulation layer (in the case of silicone resin) containing, or not containing the fluorescent material (in the case of 4,4′-bis(2-methoxystyryl)biphenyl) measured at the height of 30 cm, and 50 cm every 24 hours, respectively; and

FIG. 3 is brightness increment (%)-time curves illustrating the increased brightness percentage of the light emitting device corresponding to its encapsulation layer (in the case of silicone resin) containing the fluorescent material (in the case of 4,4′-bis(2-methoxystyryl)biphenyl) relative to its encapsulation layer not containing the fluorescent material at the height of 30 cm, and 50 cm every 24 hours, respectively.

### DETAILED DESCRIPTION OF THE PREFERRED EMBODIMENT

The present provides an enhanced brightness light emitting device, comprising: a light emitting element being capable of emitting a first light; a photoluminescent phosphor disposed over the light emitting element, the photoluminescent phosphor emitting a second light at a wavelength longer than the first light when excited by the first light; and a transparent encapsulation layer enclosing the light emitting element and the photoluminescent phosphor, the transparent encapsulation layer including a resin and a fluorescent material, which emits a third light at a wavelength longer than the first light when excited by the first light, wherein the second light, the third light, and the first light unabsorbed are combined in the encapsulation layer, and after combination a visible light is emitted outwards from the encapsulation layer, and wherein the second light and the third light fall within substantially the same wavelength range from 520 nm and 550 nm.

The fluorescent material of the present invention can be a compound represented by the following general formula:

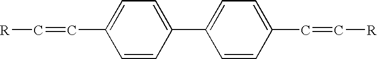

wherein R is selected from one of the group consisting of phenyl substituted with alkoxy, substituted or unsubstituted anthracene group, substituted or unsubstituted pyrene group, and substituted or unsubstituted 9,10-anthraquinone group.

Specifically, the fluorescent material used in the present invention can be 4,4′-bis(2-methoxystyryl)biphenyl, 4,4′-bis{2-(9-anthracenyl)ethylenyl}biphenyl, 4,4′-bis{2-(1-pyrenyl)ethylenyl}biphenyl, or 4,4′-bis{2-(1-anthraquinonyl)ethylenyl}biphenyl. The above-mentioned four fluorescent materials are characterized in that they are symmetric biphenyl type compounds with two ethylenyl groups at 4,4′ positions, and the biphenyl type compounds with two ethylenyl groups at 4,4′ positions are bonded to the fluorescent functional groups through two ethylenyl groups. Examples of the fluorescent functional groups are methoxyphenyl group and its homologous; anthracene group and its homologous; pyrene group and its homologous; and 9,10-anthraquinone group and its homologous. The fluorescent materials having the above-mentioned characteristics can substantially completely absorb the light having wavelength between 254 nm and 475 nm, and subsequently re-emits it as a visible light with very high brightness. When 4,4′-bis(2-methoxystyryl)biphenyl is used as the fluorescent material, it can be excited by UV light and subsequently emits a blue light having a wavelength between 450 nm and 490 nm. When 4,4′-bis{2-(9-anthracenyl)ethylenyl}biphenyl is used as the fluorescent material, it can be excited by UV light and subsequently emits a yellowish-green light having a wavelength between 520 nm and 550 nm. When 4,4′-bis{2-(1-pyrenyl)ethylenyl}biphenyl is used as the fluorescent material, it can be excited by UV light and subsequently emits a blue light having a wavelength between 450 nm and 490 nm. When 4,4′bis{2-(1-anthraquinonyl)ethylenyl}biphenyl is used as the fluorescent material, it can be excited by UV light and subsequently emits a red light having a wavelength between 580 nm and 660 nm.

Also, the fluorescent material of the present invention can be a compound selected from the group consisting of the following chemical structural formulae:

### 1. Non-Aromatic Fluorescent Materials:

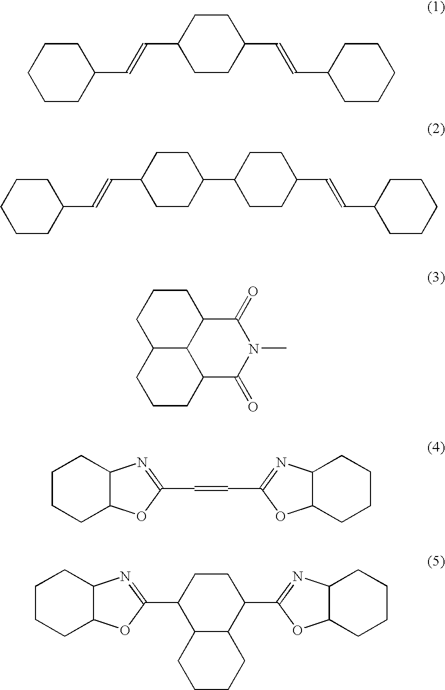

### 2. Aromatic Fluorescent Materials Containing Silicon:

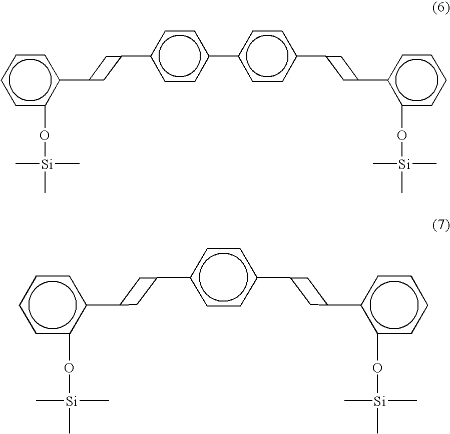

### 3. Non-Aromatic Fluorescent Materials Containing Silicon:

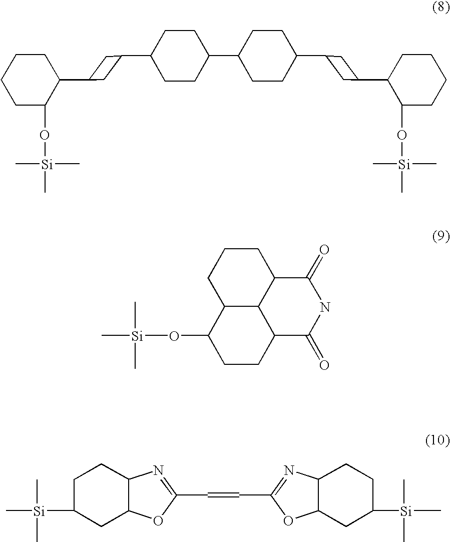

The fluorescent material of the present invention is present in an amount of from 0.001 to 0.1% by weights preferably from 0.005% to 0.01% by weight, based on the total weight of transparent encapsulation layer. The resin is present in an amount of from 99.9 to 99.999% by weight, preferably from 99.99 to 99.995% by weight, based on the total weight of transparent encapsulation layer.

The photoluminescent phosphor can be a blue phosphor that emits blue light at a wavelength from 450 nm to 490 nm when excited by the electromagnetic radiation of the light emitting element; a yellowish green phosphor that emits yellowish green light at a wavelength from 520 nm to 550 nm when excited by the electromagnetic radiation of the light emitting element; or a red phosphor that emits red light at a wavelength from 580 nm to 660 nm when excited by the electromagnetic radiation of the light emitting element.

In order to achieve the optimum brightness level, in the enhanced brightness light emitting device of the present invention, the blue phosphor is used with 4,4′-bis(2-methoxystyryl)biphenyl, or 4,4′-bis{2-(1-pyrenyl)ethylenyl}biphenyl to convert the emission of the light emitting element to the blue light; the yellowish green phosphor is used with 4,4′-bis{2-(9-anthracenyl)ethylenyl}biphenyl to convert the emission of the light emitting element to the yellowish green light; and the red phosphor is used with 4,4′-bis{2-(1-anthraquinonyl)ethylenyl}biphenyl to convert the emission of the light emitting element to the red light.

the resin of the transparent encapsulation layer can be silicone resin, or epoxy resin.

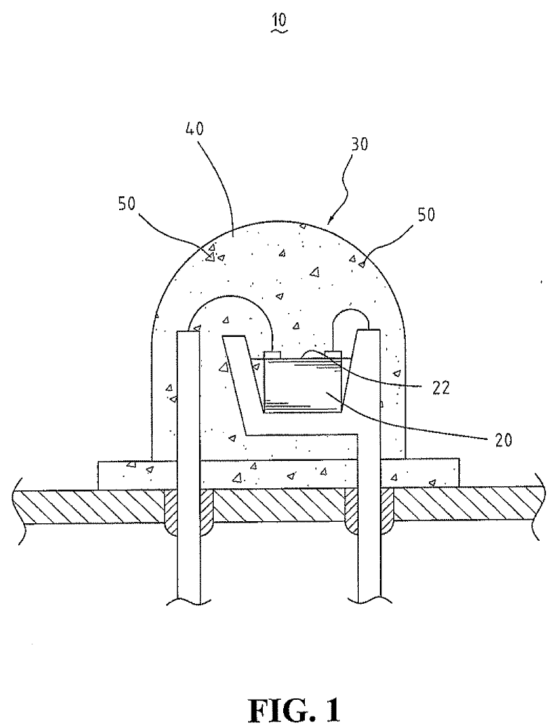

FIG. 1 is a cross-sectional view of the enhanced brightness light emitting device according to one embodiment of the present invention. In FIG. 1, the light emitting element 20 of the enhanced brightness light emitting device 10 is GaN chip which can emit UV light or blue light outwards from the output surface 22. The transparent encapsulation layer 30 is formed by mechanically mixing the silicone resin 40 with the fluorescent material of 4,4′-bis(2-methoxystyryl)biphenyl 50 in an organic solvent, applying the mixture around the light emitting element 20, and drying it. The fluorescent material is present in an amount of from 0.1 to 1% by weight. The resin is present in an amount of from 99.9 to 99% by weight, based on the total weight of transparent encapsulation layer.

### Brightness Test

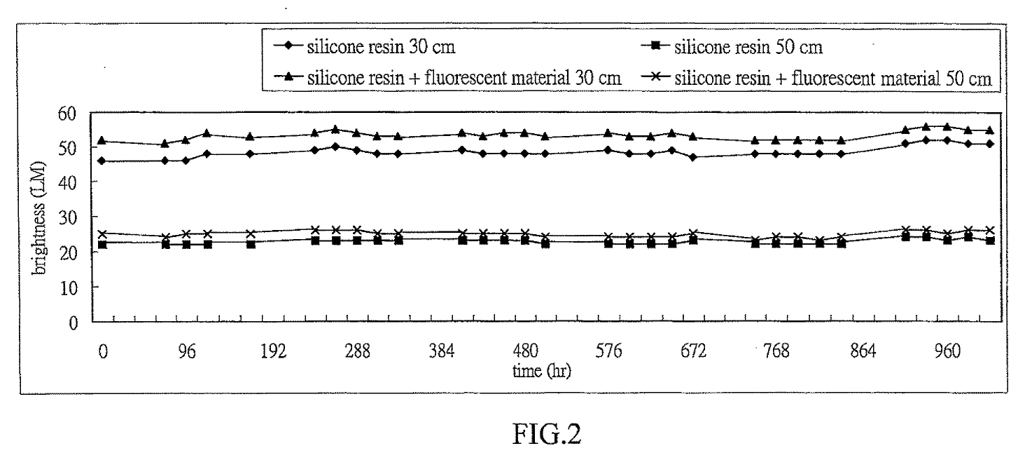

The light emitting element 20 emits a blue light with a wavelength of 465 nm when subjected to a voltage of 3.6 V, and when the blue light with a wavelength of 465 nm passes through the transparent encapsulation layer 30 including the silicone resin 40 and the fluorescent material of 4,4′-bis(2-methoxystyryl)biphenyl 50, the fluorescent material 50 converts the blue light at a wavelength of 465 nm into the blue light at a wavelength of 480 nm. The brightness (LM) of the blue light at a wavelength of 480 nm is measured at the height of 30 cm, and 50 cm every 24 hours, respectively, until the total measured time reaches a setting value of 1008 hours. The above test results are plotted in FIG. 2.

In a similar way, in the case of without the fluorescent material of 4,4′-bis(2-methoxystyryl)biphenyl 50 in the transparent encapsulation layer 30, the light emitting element 20 emits a blue light at a wavelength of 465 nm when subjected to a voltage of 3.6 V, and the blue light is then emitted outwards from the transparent encapsulation layer 30. The brightness (LM) of the blue light is measured at the height of 30 cm, and 50 cm every 24 hours, respectively, until the total measured time reaches a setting value of 1008 hours. The above test results are also plotted in FIG. 2.

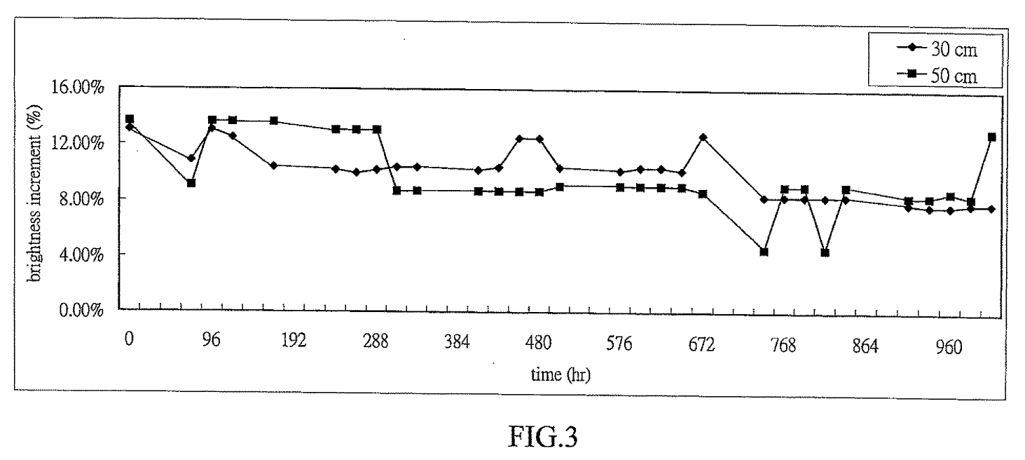

The brightness increment percentage obtained from the data shown in FIG. 2 is plotted in FIG. 3. The brightness increment percentage is calculated by dividing the brightness of the emitted blue light after passing through the transparent encapsulation layer 30 including both silicone resin 40 and the fluorescent material of 4,4′-bis(2-methoxystyryl)biphenyl 50 by the brightness of the emitted blue light after passing through the transparent encapsulation layer 30 only including silicone resin 40 at the height of 30 cm, and 50 cm, respectively (the total measured time is 1008 hours). The average brightness increment percentage at the height of 30 cm is 10.06%, and the average brightness increment percentage at the height of 50 cm is 9.74%. Therefore, if the transparent encapsulation layer of the light emitting device contains the fluorescent material of 4,4′-bis(2-methoxystyryl)biphenyl 50, the brightness of the emitted light will be greatly enhanced, and thereby the problems of color spots (such as black or yellow spots) and halo phenomena occurred in the conventional LED can be eliminated.

### Light-Emitting Efficiency Test

The light emitting element 20 is allowed to emit a first light having a wavelength of 365 nm, 375 nm, 395 nm, and 420 nm, respectively, as powered by the power supply, and then a second light with longer wavelength than the first light is emitted outwards from the transparent encapsulation layer 30 including silicone resin 40 and the fluorescent material of 4,4′-bis(2-methoxystyryl)biphenyl 50 as shown in FIG. 1. The residual light intensity, consumption intensity, and the intensity of the excited light are measured and calculated. The consumption intensity is obtained by subtracting the residual light intensity from the exciting light intensity. The light-emitting efficiency is obtained by dividing the intensity of the excited light by the consumption intensity. These results are shown in Table 1.

TABLE 1
Light-Emitting Efficiency

| | | Transparent encapsulation layer including silicone | | | |
|---|---|---|---|---|---|
| | | resin and 4,4′-bis(2-methoxystyryl)biphenyl | | | |
| Exciting light | | | | | Light- |
| Wave- | | Residual | Consumption | Intensity of | emitting |
| length | Intensity | intensity | intensity | excited light | efficiency |
| (nm) | (cd) | (cd) | (cd) | (cd) | (%) |
| 365 | 9.622024 | 0.4514948 | 9.1705292 | 3.78128 | 41.23% |
| 375 | 16.11016 | 0.7569989 | 15.3531611 | 4.759387 | 31.00% |
| 395 | 28.78808 | 1.419859 | 27.368221 | 6.282627 | 22.96% |
| 420 | 57.89266 | 2.580826 | 55.311834 | 7.07375 | 12.79% |

As seen from Table 1, when the exciting light having a wavelength of 365 nm is used, the light-emitting efficiency is the best.

### Required Concentration of the Fluorescent Material Test

The light emitting element 20 is allowed to emit a first light having a wavelength of 450 nm, and 550 nm, respectively, as powered by the power supply (20 mA current), and then a second light with longer wavelength than the first light is emitted outwards from the transparent encapsulation layer 30 consisting of the silicone resin 40 and the fluorescent material represented by the following chemical structural formula:

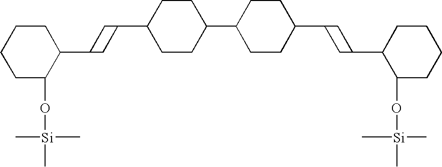

The fluorescent material is present in an amount of 1 ppm, 2 ppm, 5 ppm, and 10 ppm, respectively, in the transparent encapsulation layer 30. The brightness (LM) of the light emitting element 20 is measured. These results are shown in Table 2.

TABLE 2

| | mcd | | | | |
|---|---|---|---|---|---|
| | in the absence of | | | | |
| | the fluorescent | | | | |
| nm | material | 1 ppm | 2 ppm | 5 ppm | 10 ppm |
| 450 nm | 5120 | 6100 | 6300 | 6000 | 5800 |
| 550 nm | 7500 | 8600 | 9100 | 8800 | 8500 |

It can be seen from Table 2 that when the encapsulation layer contains the fluorescent material of the present invention at a concentration of 1 ppm, 2 ppm, 5 ppm, and 10 ppm, respectively, the brightness can be increased.

In the other case, the light emitting element 20 is allowed to emit a first light having a wavelength of 450 nm, and 550 nm, respectively, as powered by the power supply (20 mA current), and then a second light with longer wavelength than the first light is emitted outwards from the transparent encapsulation layer 30 consisting of the silicone resin 40 and the fluorescent material of 4,4′-bis(2-methoxystyryl)biphenyl 50, and the fluorescent material is present in an amount of from 0.005% to 0.01% by weight based on the total weight of the encapsulation layer 30, as shown in FIG. 1. These results are shown in Table 3.

TABLE 3

| | mcd | | |
|---|---|---|---|
| | in the absence of the | | |
| nm | fluorescent material | 0.005 wt % | 0.01 wt % |
| 450 nm | 5120 | 4900 | 4850 |
| 550 nm | 7500 | 7300 | 7100 |

It can be seen from Table 3 that when the encapsulation layer contains the conventional fluorescent material (such as 4,4′-bis(2-methoxystyryl)biphenyl) at a concentration ranging from 0.005 to 0.01 wt % based on the total weight of the encapsulation layer, the brightness actually is decreased.

Table 4 shows the wavelengths and the CIE chromaticity coordinates of the excited lights in this test.

TABLE 4

Excited light

| Exciting light | | CIE chromaticity |
|---|---|---|
| Wavelength (nm) | Wavelength (nm) | coordinates |
| 365 | 480 | x = 0.1477, y = 0.2193 |
| 375 | 480 | x = 0.1468, y = 0.2189 |
| 395 | 480 | x = 0.1449, y = 0.2175 |
| 420 | 480 | x = 0.1439, y = 0.2177 |

As seen from Table 4, the excited lights all fall in the range of the blue light spectrum.

Brightness vs. Concentration of the Fluorescent Material

The light emitting element 20 is allowed to emit a first light having a wavelength of 455 nm, 460 nm, 465 nm, and 470 nm, respectively, as powered by the power supply (20 mA current), and then a second light with longer wavelength than the first light is emitted outwards from the transparent encapsulation layer 30 consisting of the silicone resin 40, and 8 to 15 wt % of YAG: Ce³⁺ (designated by YAG in Table 5) together with 1 to 5 wt % of the fluorescent material represented by the following chemical structural formula (designated by ST in Table 5):

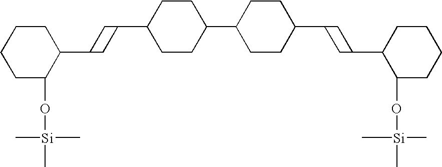

The brightness and the CIE chromaticity coordinates are measured as shown in Table 5.

TABLE 5

| | 8 wt % | 9 wt % | 10 wt % | 11 wt % | 12 wt % | 13 wt % | 14 wt % | 15 wt % |
|---|---|---|---|---|---|---|---|---|
| ST (1%) + YAG | | | | | | | | |
| X | 0.255 | 0.253 | 0.254 | 0.255 | 0.254 | 0.26 | 0.265 | 0.279 |
| Y | 0.341 | 0.339 | 0.341 | 0.343 | 0.355 | 0.367 | 0.385 | 0.401 |
| mcd (avg.) | 9932 | 9812 | 9702 | 9573 | 9488 | 9312 | 9289 | 9210 |
| ST (2%) + YAG | | | | | | | | |
| X | 0.24 | 0.243 | 0.248 | 0.247 | 0.256 | 0.265 | 0.269 | 0.275 |
| Y | 0.311 | 0.317 | 0.33 | 0.334 | 0.344 | 0.358 | 0.361 | 0.373 |
| mcd (avg.) | 9769 | 9762 | 9529 | 9501 | 9410 | 9375 | 9333 | 9295 |
| ST (3%) + YAG | | | | | | | | |
| X | 0.254 | 0.256 | 0.255 | 0.258 | 0.261 | 0.276 | 0.278 | 0.28 |
| Y | 0.361 | 0.36 | 0.363 | 0.367 | 0.383 | 0.402 | 0.408 | 0.413 |
| mcd (avg.) | 9528 | 9476 | 9443 | 9378 | 9335 | 9289 | 9266 | 9176 |
| ST (4%) + YAG | | | | | | | | |
| X | 0.214 | 0.222 | 0.244 | 0.248 | 0.257 | 0.276 | 0.281 | 0.282 |
| Y | 0.305 | 0.322 | 0.337 | 0.352 | 0.355 | 0.367 | 0.377 | 0.394 |
| mcd (avg.) | 9276 | 9177 | 9126 | 9120 | 9004 | 8978 | 8871 | 8750 |
| ST (5%) + YAG | | | | | | | | |
| X | 0.23 | 0.241 | 0.255 | 0.27 | 0.286 | 0.288 | 0.295 | 0.296 |
| Y | 0.311 | 0.333 | 0.347 | 0.359 | 0.363 | 0.37 | 0.381 | 0.384 |
| mcd (avg.) | 9599 | 9419 | 9354 | 9131 | 8898 | 8811 | 8721 | 8686 |

As seen from Table 5, 1 wt % of the fluorescent material is preferably used.

Brightness vs. Fluorescent Material used at 460 nm

The light emitting element 20 is allowed to emit a first light having a wavelength of 460 nm, respectively, as powered by the power supply (20 mA current), and then a second light with longer wavelength than the first light is emitted outwards from the transparent encapsulation layer 30 including silicone resin 40, and 8 to 15 wt % of YAG: Ce³⁺ (designated by YAG in Table 6) 50 or 1 wt % of the fluorescent material represented by the following chemical structural formula (designated by ST in Table 6):

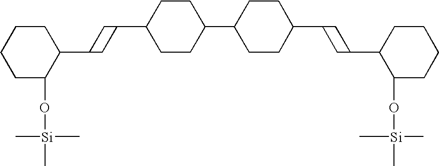

The brightness and the CIE chromaticity coordinates are measured as shown in Table 6.

TABLE 6

| YAG | 8 wt % | 9 wt % | 10 wt % | 11 wt % | 12 wt % | 13 wt % | 14 wt % | 15 wt % |
|---|---|---|---|---|---|---|---|---|
| 1 X | 0.282 | 0.299 | 0.315 | 0.313 | 0.3 | 0.329 | 0.318 | 0.34 |
| Y | 0.389 | 0.421 | 0.45 | 0.44 | 0.422 | 0.472 | 0.459 | 0.489 |
| mcd (avg.) | 5470 | 6707 | 6531 | 6014 | 4924 | 4299 | 4702 | 5094 |

| ST | 1 wt % |
|---|---|
| X | 0.19 |
| Y | 0.125 |
| mcd (avg.) | 5135 |

As seen from Table 6, the brightness of the light emitting device using 1 wt % of the fluorescent material of the present invention is comparable with the brightness of the light emitting device using 8 to 15 wt % of YAG at 460 nm.

The fluorescent materials of the present invention used in the transparent encapsulation layer of the light-emitting device have the advantages of (1) only 0.005 to 0.01 wt % of the fluorescent material is required to increase the brightness of the LEDs; (2) the LEDs with the fluorescent materials of the present invention can be operated under high voltage and high temperature (>300° C.) for a long time without deterioration of performance; (3) the fluorescent materials of the present invention is compatible with silicone resins which are widely used as an encapsulating material for LEDs; (4) when the blue LEDs are used with the fluorescent materials of the present invention, the wavelength of 450 nm or below emitted by the blue LEDs can be eliminated; (5) the LEDs with YAG and the fluorescent materials of the present invention can be operated under violet or UV light irradiation to enhance the brightness thereof, and however the LEDs with YAG can be only operated under blue light irradiation to enhance brightness thereof; and (6) the brightness of the light emitted by the light emitting element can be greatly enhanced through the fluorescent materials of the present invention so that the problems of color spots (such as black or yellow spots) and halo phenomena occurred in the conventional LEDs can be eliminated.

It will be apparent to those skilled in the art that various modifications and variations can be made in the present invention without departing from the spirit or scope of the present invention. Thus, it is intended that the present invention cover the modifications and the variations of this invention provided they come within the scope of the appended claims and their equivalents.

What is claimed is:

1. An enhanced brightness light emitting device, comprising:
a light emitting element being capable of emitting a first light;
a photoluminescent phosphor disposed over the light emitting element, the photoluminescent phosphor emitting a second light at a wavelength longer than the first light when excited by the first light; and
a transparent encapsulation layer enclosing the light emitting element and the photoluminescent phosphor, the transparent encapsulation layer including a resin and a fluorescent material, which emits a third light at a wavelength longer than the first light when excited by the first light, the fluorescent material being selected from the group consisting of the following chemical structural formulae (1) to (10): 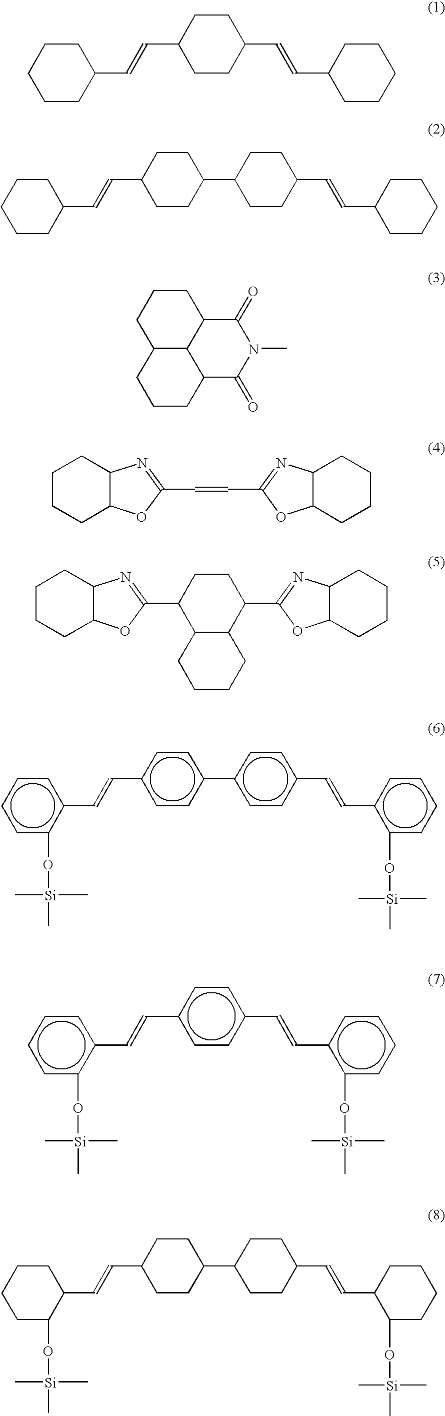 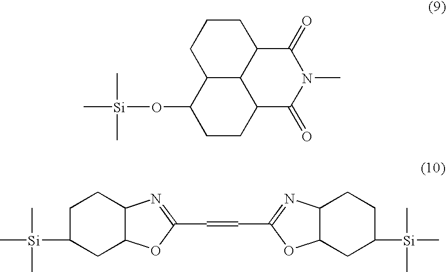
wherein the second light, the third light, and the first light unabsorbed are combined in the encapsulation layer, and after combination a visible light is emitted outwards from the encapsulation layer, and
wherein the second light and the third light fall within substantially the same wavelength range from 520 nm and 550 nm.

2. The enhanced brightness light emitting device as claimed in claim 1, wherein the light emitting element is a GaN chip.

3. The enhanced brightness light emitting device as claimed in claim 1, wherein the first light has a wavelength between 254 nm and 475 nm.

4. The enhanced brightness light emitting device as claimed in claim 1, wherein the resin is silicone resin, or epoxy resin.

5. The enhanced brightness light emitting device as claimed in claim 1, wherein the resin is present in an amount of from 99.99 to 99.995% by weight of total weight of the encapsulation layer

6. The enhanced brightness light emitting device as claimed in claim 1, wherein the fluorescent material is present in an amount of from 0.005% to 0.01% by weight of total weight of the encapsulation layer.

7. The enhanced brightness light emitting device as claimed in claim 1, wherein the photoluminescent phosphor includes YAG:Ce³⁺.
